(19) United States
(12) Patent Application Publication
(10) Pub. No.: US 2007/0200097 A1
(43) Pub. Date: Aug. 30, 2007

(54) Glass Composition That Emits Fluorescence In Infrared Wavelength Region And Method Of Amplifying Signal Light Using The Same

(75) Inventors: Shoichi Kishimoto, Tokyo (JP); Shigeki Nakagaki, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: NIPPON SHEET GLASS COMPANY LIMITED, MINATO-KU TOKYO, JAPAN (JP)

(21) Appl. No.: 10/590,420

(22) PCT Filed: Feb. 25, 2005
(86) PCT No.: PCT/JP05/03217

§ 371 Date: Aug. 23, 2006

(30) Foreign Application Priority Data
Mar. 3, 2004 (JP) 2004-058739

(51) Int. Cl. C09K 11/06; C03C 13/04; C03C 3/253

(52) U.S. Cl. 252/301.33; 501/37; 501/42

(57) ABSTRACT

The present invention provides a glass composition that exerts an emission function or an optical amplification function in a wide wavelength range. The glass composition contains, bismuth oxide, aluminium oxide, and a glass network former, and a main component of the glass network former is germanium dioxide. Bismuth contained in bismuth oxide functions as an emission species and emits fluorescence in the infrared wavelength region by irradiation of excitation light. The glass composition may further contain a monovalent or divalent metal oxide.

### TECHNICAL FIELD

The present invention relates to a glass composition that can function as a light emitter or an optical amplification medium.

### BACKGROUND ART

Glasses that contain rare earth elements such as Nd, Er and Pr and emit fluorescence in the infrared region have been known. Laser emissions and optical amplifications using these glasses had been studied mainly in the 1990's. The light emissions from these glasses are generated by radiative transition of 4f electrons in rare earth ions. The 4f electron is shielded by outer shell electrons, and therefore a wavelength region in which light emission can occur is narrow. Consequently, a wavelength range in which light is amplified and a wavelength range capable of laser oscillation are limited.

In consideration of the above points, JP-A-11-317561 and JP-A-2001-213636 disclose glass compositions that contain large amounts of Bi₂O₃ (ex. 20 mol % or more) and Er as a luminescent element and can be used in the wavelength range of 80 nm or more. However, an emission species is Er and it limits the expansion of the wavelength range to approximately 100 nm. Furthermore, the refractive indices of the glass compositions are about 2, which is relatively high, and thereby a problem of reflection at the interface is caused easily in the case of the connection with an optical fiber made of a silica glass used for optical communication.

JP-A-6-296058, JP-A-2000-53442 and JP-A-2000-302477 disclose glass compositions that contain Cr or Ni as a luminescent element and have a wide wavelength range for emission. A main component of the glass composition wherein its luminescent element is Cr is Al₂O₃, and the content of a glass network former is limited to a small amount (20 mol % or less). Hence, this glass composition tends to devitrify during melting or forming. For the glass composition wherein Ni is a luminescent element, it is necessary that the glass composition contains at least one of Ni⁺ ion, microcrystal including Ni²⁺ ion, and Ni ion having a hexacoordinate structure, and fine particles of metal Ni deposit at the same time. Therefore, this glass composition also tends to devitrify.

JP-A-11-29334 discloses silica glasses in which Bi is doped. In this glass composition, Bi is clustered in a zeolite so that a wavelength range of emission is broadened. In this silica glass, however, Bi is clustered to come very close to each other and therefore deactivation between adjacent Bi ions tends to occur and the efficiency of optical amplification is low. Since this silica glass is produced using a sol-gel method, it will cause the problem of shrinkage during drying and cracks during sintering upon mass production of large-size glasses or optical fibers.

JP-A-2002-252397 discloses an optical fiber amplifier using a Bi₂O₃—Al₂O₃—SiO₂ based silica glass. The use of this silica glass enables optical amplification in the 1.3 μm range using a laser diode with 0.8 μm range as an excitation light source. This amplifier has excellent compatibility with silica glass based optical fibers. However, this silica glass needs to be melted at 1750° C. or higher, and its deformation point reaches 1000° C. or higher. Therefore, production of optical fibers is not easy. Even if the optical fibers are produced, transmittance will result in low.

### DISCLOSURE OF THE INVENTION

An object of the present invention is to provide a novel glass composition that exerts an emission function or an optical amplification function in the infrared wavelength region, particularly in a wide wavelength range employed for optical communication.

The glass composition according to the present invention is characterized in that the glass composition contains bismuth oxide, aluminium oxide, and a glass network former, a main component of the glass network former is germanium dioxide, and bismuth contained in bismuth oxide functions as an emission species and emits fluorescence in an infrared wavelength region by irradiation of excitation light.

In the present specification, “a main component” means a component having the largest content.

According to the present invention, a glass composition that emits fluorescence in a wide wavelength range of the infrared region and melts at a lower temperature than a silica glass is provided.

### BRIEF DESCRIPTION OF THE DRAWINGS

FIG. 1 is a diagram showing an example of the optical amplifier of the present invention used as an optical system for evaluating optical amplification characteristics.

FIG. 2 is a diagram showing an optical detection system for 1100 nm ranges in an optical system for evaluating optical amplification characteristics.

FIG. 3 is a diagram showing an optical detection system for 1300 nm ranges in an optical system for evaluating optical amplification characteristics.

FIG. 4 is a diagram showing another example of the optical amplifier of the present invention used as an optical system for evaluating optical amplification characteristics of an optical fiber.

FIG. 5 is a diagram showing an example of optical transmission spectra of the glass compositions of the present invention.

FIG. 6 is a diagram showing an example of fluorescence spectra of the glass composition of the present invention.

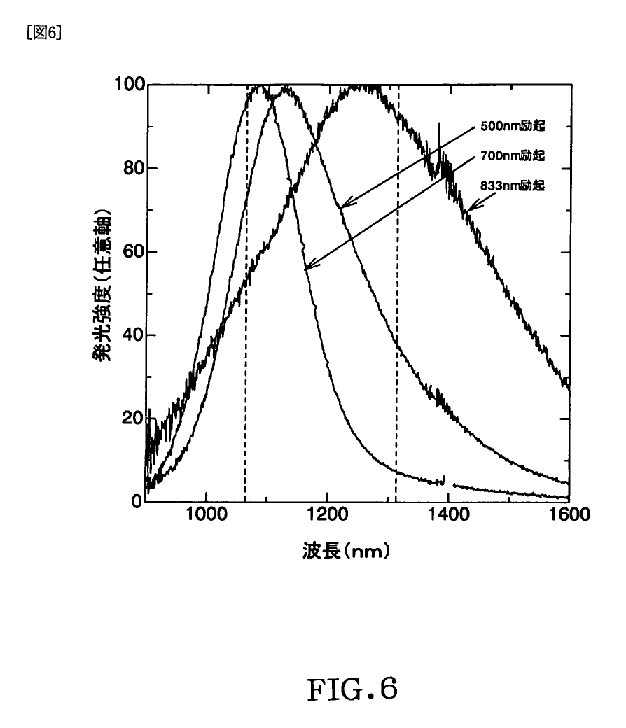

### BEST MODES OF EMBODIMENTS OF THE INVENTION

Hereinafter, all the %-indications that indicate composition denote “mol %”.

The glass composition of the present invention contains bismuth oxide, aluminium oxide (Al₂O₃), and a glass network former as essential components. Al₂O₃ has too low capability of forming a glass network to be classified as a glass network former. Although a typical glass network former is silicon oxide, a main component of the glass network former in the present invention is germanium dioxide (GeO₂). The glass composition can have a deformation point of 750° C. or lower.

It is preferable that the glass composition of the present invention have an optical absorption peak in the wavelength range of 400 nm to 1100 nm, preferably 400 nm to 900 nm. It is preferable that the optical absorption peak exists in one, preferably two or more wavelength ranges, selected from the wavelength ranges of 400 nm to 550 nm, 650 nm to 750 nm, and 750 nm to 850 nm.

When excitation light with wavelength in the range of 400 nm to 1100 nm, more particularly 400 nm to 850 nm is irradiated to the glass composition of the present invention, the wavelength wherein the intensity of fluorescence emitted becomes highest is in the range of, for example, 900 nm to 1600 nm, preferably 1000 nm to 1600 nm, and more preferably 1000 nm to 1400 nm. According to the present invention, a half width to this wavelength of the fluorescence can be broadened to at least 150 nm, even at least 320 nm, for example, not less than 150 nm and not more than 400 nm. At least the fact that an emission species is a cation of bismuth contributes to this wide full-width at half maximum. The glass composition of the present invention may constitute an optical amplification media that provides gain in the wavelength range of at least a part of 900 nm to 1600 nm by irradiation of the excitation light.

The glass composition of the present invention preferably further contains a monovalent or divalent metal oxide. These oxides make vitrification easy. The divalent metal oxide is preferably one selected from MgO, CaO, SrO, BaO and ZnO. The monovalent metal oxide is preferably one selected from Li₂O, Na₂O and K₂O. Since MgO and Li₂O are preferable components, it is preferable that the glass composition contains at least one of the two oxides. The suitable content of the monovalent or divalent metal oxide is 3 to 40%.

In the glass composition of the present invention, the content of bismuth oxide in terms of Bi₂O₃ is 0.01 to 15%, particularly preferably 0.01 to 5%. The content of aluminium oxide is preferably 0.5 to 33%, and the content of germanium dioxide is preferably 40 to 85%.

A preferable composition of the glass composition of the present invention is exemplified below. The glass composition contains components indicated as follows: 40 to 85% GeO₂; 0.5 to 33% Al₂O₃; 0 to 30% Li₂O; 0 to 30% Na₂O; 0 to 30% K₂O; 0 to 40% MgO; 0 to 30% CaO; 0 to 30% SrO; 0 to 30% BaO; 0 to 25% ZnO; 0 to 10% TiO₂; 0 to 5% ZrO₂; and 0 to 20% SiO₂, wherin the total of MgO+CaO+SrO+BaO+ZnO+Li₂O+Na₂O+K₂O (MO+R₂₀) is in the range of 3 to 40%, and the composition further contains 0.01 to 15% of bismuth oxide in terms of Bi₂O₃.

In order to prevent the reduction of bismuth, a part of the raw glass materials may be replaced by a sulfate salt or a nitrate salt. Bismuth oxide or a source material of bismuth oxide preferably is melted together with at least one selected from the sulfate salt and the nitrate salt. It is recommended that the amount of the sulfate salt and the nitrate salt is more than 1/20 or more in a molar ratio relative to bismuth trioxide.

Hereinafter, methods for evaluating the characteristics of specific embodiments of the glass composition of the present invention are described.

(Optical Transmission Spectrum)

A glass sample was cut and mirror-polished into a parallel plate with the size of 20 mm×30 mm×thickness 3 mm and a plate sample was thus prepared. An optical transmission spectrum of the plate sample was measured in the wavelength of 290 to 2500 nm using a commercial spectrophotometer. The presence or absence of an optical absorption peak in the wavelength range of each of 400 to 550 nm and 650 to 750 nm of the optical transmission spectrum was also ascertained.

A half width of the optical absorption spectrum was measured as follows: First, the optical transmission spectrum was converted into a molar absorption coefficient (that is to say, bismuth oxide was converted into Bi₂O₃ and then an absorption coefficient in the case of 1% content of this Bi₂O₃ and 1 cm optical path length was calculated) so that an optical absorption spectrum was prepared. A baseline was made by drawing a common tangent from the both tails of the peak in the optical absorption spectrum. A top line was drawn so that the top line was parallel to the baseline and contacted with the peak. Further, a middle line was drawn so that the middle line was parallel to these lines and divided an area between the top line and the baseline into two parts. Then, the wavelength difference between two points at the intersections of the middle line and the spectrum was defined as the half width (full-width at half maximum).

(Fluorescence Spectrum)

A fluorescence spectrum was measured with a commercial spectrophotofluorometer, using the same plate sample as above. The fluorescence spectrum of the fluorescence emission in the wavelength range of 800 nm to 1600 nm was measured on each of excitation lights having the prescribed wavelength. It should be noted that the sample temperature during the measurement was room temperature.

With respect to a peak that appeared in the measured fluorescence spectrum, an emission peak wavelength, a wavelength width (emission half width) when emission intensity was not less than a half of the peak value, and emission intensity at the emission peak wavelength were measured. Although the emission intensity is represented by an arbitrary unit, its comparison is possible since the shape of the samples and the position where the samples are placed during the measurement are the same. The emission half width was measured in the manner similar to the measurement of the half width of the optical absorption peak.

(Fluorescence Lifetime)

A fluorescence lifetime also was measured with the spectrophotofluorometer, using the same plate sample as above. Attenuation versus time, of emission induced by excitation using pulsed light with the prescribed wavelength was measured. This measurement was carried out at the prescribed wavelength corresponding to the excitation wavelength, for example 1140 nm corresponding to an excitation wavelength of 500 nm, 1120 nm corresponding to an excitation wavelength of 700 nm, and 1250 nm corresponding to an excitation wavelength of 833 nm. A fluorescence lifetime was calculated by fitting an exponential curve to the decay curve thus obtained.

(Optical Amplification Characteristics)

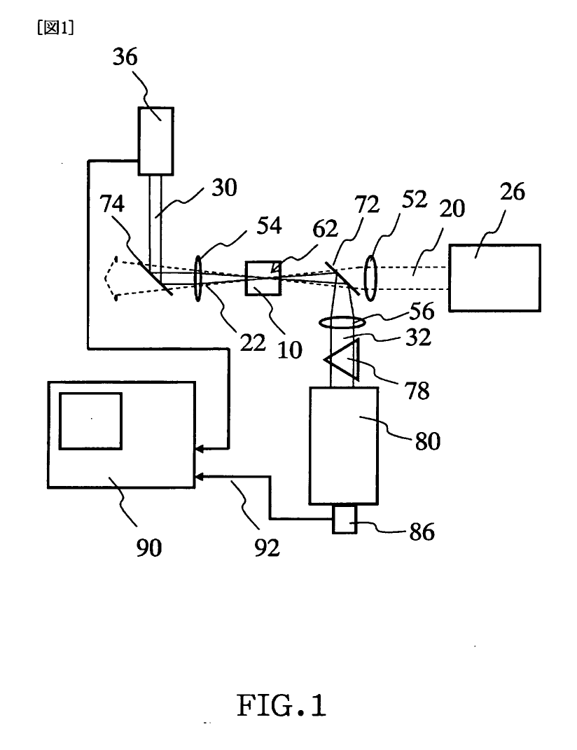

Optical amplification characteristics were measured using the measuring device shown in FIG. 1. A wavelength of excitation light, which could be an energy source for optical amplification, was set to be 532 nm, and a wavelength of signal light to be amplified was set to be two kinds, that is to say 1064 nm and 1314 nm. In this device, the excitation light overlaps with the signal light spatially in the glass sample, and the signal light that penetrates the glass sample will be amplified.

Continuous light emitted from laser diode (LD) pumped Nd:YAG green laser was used as a light source 26 of excitation light 20 with wavelength of 532 nm. The excitation light 20 was focused with a convex lens 52 with focus distance of 300 mm, and the position of the lens 52 and the like were adjusted so that a focus position 62 was located at the central part in the thickness direction of a glass sample 10.

On the other hand, when a wavelength of a signal light 30 was 1064 nm, a laser diode pumped Nd:YAG laser 36 was used as the light source separately from the excitation light source 26, and the signal light 30 was pulsed light with pulse amplitude ns. When the wavelength was 1314 nm, signal light 30 was continuous light from the laser diode 36 with wavelength of 1314 nm. The signal light 30 was injected into the glass sample 10 from the opposite direction from the excitation light 20 and focused with a convex lens 54 with focus distance of 500 mm or 1000 mm. The position of the lens 54 and the like were adjusted so that the focus position 62 was located at the central part in the thickness direction of the glass sample 10. The combination of focus distances of the lens 52 and the lens 54 was selected so that space through which a signal light beam passed was fully included in space through which an excitation light beam passed.

Multiplexing and demultiplexing of the signal light 30 and the excitation light 20 were performed using wavelength-selective reflecting mirrors 72 and 74. These reflecting mirrors 72 and 74 were configured so that the excitation light 20 could pass through them while the signal light 30 was reflected.

When the wavelength of the signal light was 1064 nm, a normal transparent glass sheet was used as a reflecting mirror of the signal light. In the case of the transparent glass sheet, several % of reflection can occur on its surface. A part of signal light 30 with the wavelength of 1064 nm emitted from the light source (Nd:YAG laser) 36 is reflected on the reflecting mirror 74 and is injected into the glass sample 10. The signal light 32 that has passed through the glass sample 10, that is to say amplified signal light 32, is partially reflected on the reflecting mirror 72 and converted into parallel light by a lens 56. Then excitation light component is eliminated by a dispersing prism 78 and the signal light 32 is guided into an optical detection system 80.

Although the reflectivity of the light with wavelength of 1064 nm on the two reflecting mirrors 72 and 74 is not high, the measurement is carried out easily since the signal light 30 is pulsed light and its peak value is very large (megawatt level at the position of the laser emission). It should be noted that the excitation light 20 passes through reflecting mirror 72 with little loss, and reaches the glass sample 10. The excitation light 22 that has not contributed to the optical amplification of the glass sample reaches the reflecting mirror 74. The reflection amount on this reflecting mirror is very small, and therefore it causes no negative effect on the light source 36.

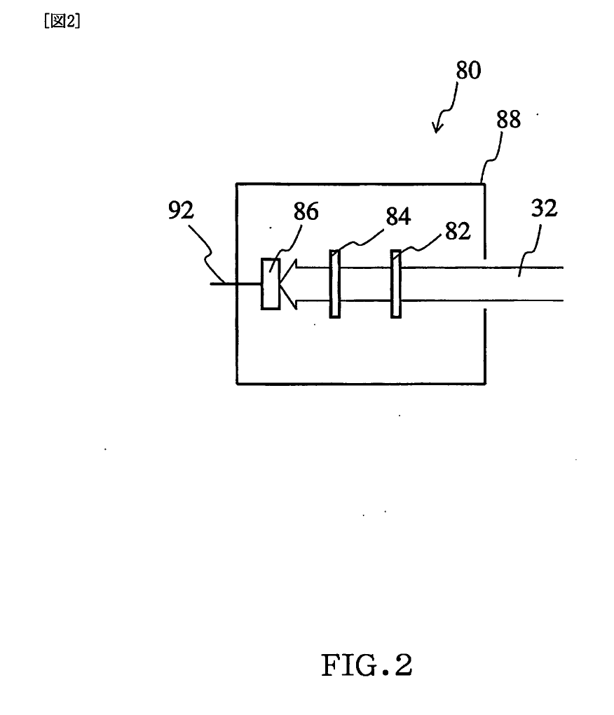

Detail of the optical detection system 80 when the wavelength of the signal light is 1064 nm is shown in FIG. 2. The signal light 32 that has been guided into the optical detection system 80 covered with a shading cover 88 is allowed to pass through a visible light cut filter 82 and then pass through an interference filter 84, which lets only the light with wavelength of 1064 nm pass, so that the light other than the signal light components is eliminated. The signal light is converted into an electrical signal corresponding to the signal light intensity by a photodetector 86 and goes through a signal cable 92 so that it is displayed on an oscilloscope 90. As the photodetector 86, for example, Si based photodiode may be used.

When the wavelength of the signal light was 1314 nm, dielectric multilayer film mirrors that had a high reflectivity at the wavelength of 1314 nm were used as reflecting mirrors 72 and 74. The signal light 30 with the wavelength of 1314 nm emitted from the signal light source (LD) 36 is reflected on the reflecting mirror 74 and is injected into the glass sample 10. The amplified signal light 32 is reflected on the reflecting mirror 72 and guided into the optical detection system 80. The excitation light 20 passes through reflecting mirror 72 with little loss, and reaches the glass sample 10. The excitation light 22 that has not contributed to the optical amplification reaches the reflecting mirror 74 and is reflected in a small amount. In order to prevent this reflected light from entering the signal light source 36, a dielectric multilayer film mirror (not shown) which was constituted to have a high reflectivity at the wavelength of 532 nm was inserted.

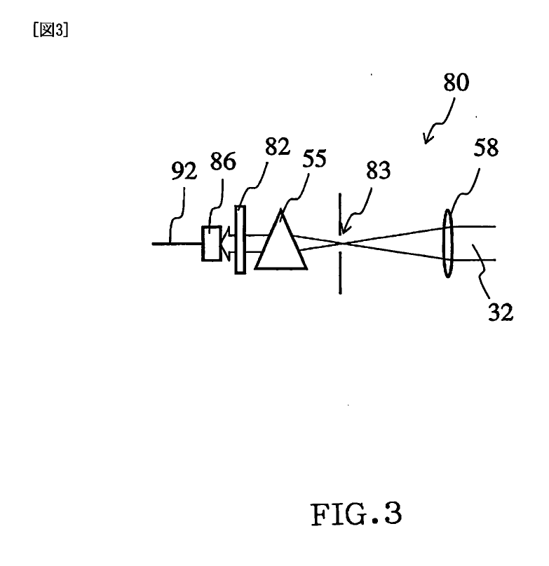

Detail of the optical detection system 80 when the wavelength of the signal light is 1314 nm is shown in FIG. 3. The signal light 32 that has been guided into the optical detection system 80 is focused with lens 58 with a long focus distance (e.g., 1000 nm) near a pinhole 83. The components that progress in the direction other than the signal light, that is to say components of ASE (Amplified Spontaneous Emission) light and scattered light, can be eliminated by letting the light go through the pinhole. Furthermore, by letting the light go through a spectroscopic prism 55, the component of excitation light with wavelength of 532 nm is eliminated and only the signal light component is allowed into the photodetector 86. The signal light is converted into an electrical signal corresponding to it and goes through a signal cable 92 so that it is displayed on an oscilloscope. As the photodetector 86, for example, Ge based photodiode may be used.

In the optical system shown in FIG. 1, the direction in which the excitation light 20 traveled was opposite to the direction in which the signal light 30 traveled. The optical system, however, is not limited thereto. For instance, the directions in which the respective lights travel may be the same. The shape of the glass sample may be not only a block-form but also a fiber-form.

The measurement of the optical amplification using the above-described optical system was performed as explained below.

The glass sample 10 was mirror-polished so that the both surfaces of the glass sample 10 were parallel, and the block sample was thus obtained. The thickness of the glass sample was set to be the thickness wherein the transmittance at the wavelength of the excitation light, for example the wavelength of 523 nm, was about 95%. This glass sample was placed at the position shown in FIG. 1, and the position of the glass position was adjusted so that the signal light 30 and the excitation light 20 were sufficiently overlapped inside the glass sample 10.

After that, first, the signal light 30 was irradiated to the glass sample 10, and intensity of the signal light 32 that had passed through the glass sample 10 was measured with the oscilloscope 90. Then, while the signal light 30 was being irradiated, the excitation light 20 was irradiated to the glass sample 10 and the intensity of the signal light 32 was measured with oscilloscope 90 in a similar manner. By comparing the intensity of the transmitted signal light in the case of the irradiation of only the signal light with the intensity of the transmitted signal light in the case of the simultaneous irradiation of the signal light and excitation light, the optical amplification phenomenon can be confirmed.

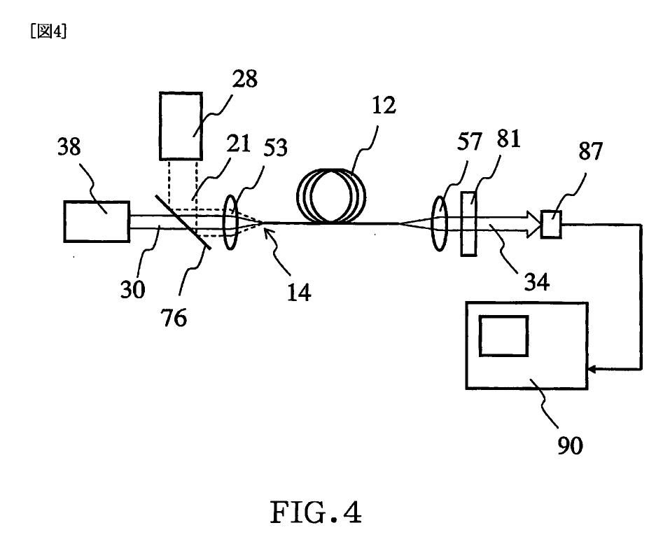

It should be noted that when the shape of the glass sample is in a fiber-form (when optical fiber including the glass composition of the present invention is used), its optical amplification characteristics can be measured using the measuring device shown in FIG. 4. It is recommended that the wavelength of excitation light 21, which is an energy source of the optical amplification, be, for example, 808 nm, and that the wavelength of signal light 30 to be amplified be 1314 nm. In this device, the excitation light 21 and the signal light 30 are overlapped spatially near an end 14 of an optical fiber, which is an entrance to the fiber core sample, and signal light 34 that has passed through the fiber sample 12 is amplified.

For each of the light sources 28 and 38 of the excitation light with wavelength of 808 nm and the signal light of the wavelength of 1314 nm, continuous light emitted from a laser diode may be used. The multiplexing of the signal light and the excitation light may be preformed using a wavelength-selective reflecting mirror 76 that has a constitution wherein the signal light 30 passes through but the excitation light 21 is reflected.

Light 34 released from the optical fiber 12 is guided to a photodetector 87 by a lens 57. A filter 81 that transmits the signal light and shields the excitation light is inserted at the middle of the light path, and only the signal light is detected by the detector 87 and observed with oscilloscope 90.

In the optical amplification measurement using the above-mentioned optical system, the optical fiber sample is cut so that the cross-sectional surface forms a mirror surface. The optical fiber sample is placed in the above measuring device and adjusted so that the signal light and the excitation light are injected sufficiently into the core of the optical fiber.

After that, first, the signal light 30 is irradiated to an end face 14 of the optical fiber sample 12, and intensity of the signal light 34 that has passed through the optical fiber sample 12 is measured with the oscilloscope 90. Then, while the signal light 30 is being irradiated, the excitation light 21 is irradiated to the optical fiber sample 12 and intensity of the signal light 34 is measured with oscilloscope 90. By comparing the intensity of the transmitted signal light in the case of the irradiation of only the signal light with the intensity of the transmitted signal light in the case of the simultaneous irradiation of the signal light and excitation light, the optical amplification phenomenon can be confirmed.

In the optical system shown in FIG. 4, the direction in which the excitation light traveled is the same as the direction in which the signal light traveled. The optical system, however, is not limited thereto. For instance, the directions in which the respective lights travel may be opposite to each other. The signal light may be reflected on the wavelength-selective reflecting mirror and the excitation light may pass through the wavelength-selective reflecting mirror. The signal light and the excitation light may be injected into the optical fiber by means other than the reflecting mirror.

The devices shown in FIG. 1 and FIG. 4, particularly FIG. 4, are examples of the evaluation device as well as configuration examples of the optical amplifier of the present invention. The configuration of the optical amplifier is not limited to that shown in the figures. For instance, a signal-input optical fiber and a signal-output optical fiber may be disposed instead of the light source of the signal light and the photodetector, respectively. In addition, the excitation light and the signal light may be multiplexed/demultiplexed using a fiber coupler. By using such an optical amplifier, the method of amplifying the signal light, including injecting the excitation light and the signal light into the glass composition of the present invention and thereby amplifying the signal light can be carried out.

Hereinafter, the present invention is described further in detail using examples.

### EXAMPLES

Germanium dioxide, alumina, lithium carbonate, sodium carbonate, potassium carbonate, magnesium oxide, calcium carbonate, strontium carbonate, barium carbonate, titania, zirconia, zinc oxide, silica, bismuth trioxide(Bi₂O₃) and the like, which were used generally as raw materials, were weighed so that the respective compositions shown in Table 1 were obtained. Then raw material batches were prepared.

For the purpose of preventing bismuth trioxide from being unnecessarily reduced and of clarifying the glass, magnesium sulfate (MgSO₄) that was commercially available as an agent was used as a part of a source material of MgO. Further, with respect to the composition containing Na₂O, sodium sulfate (salt cake Na₂SO₄) was used as a part of the source material of Na₂O. The amount of these sulfate salts was set to be 1/20 or more in a molar ratio relative to bismuth trioxide.

Each batch thus prepared was put into an alumina crucible and was maintained in an electric furnace at 1400° C. for four hours. Thereafter, the batch was cast on an iron plate to be cooled. After this glass was maintained in an electric furnace at 600° C. for 30 minutes, the power of the furnace was turned off and the glass then was cooled slowly to room temperature. Thus, glass samples (Samples 1 to 7) were obtained.

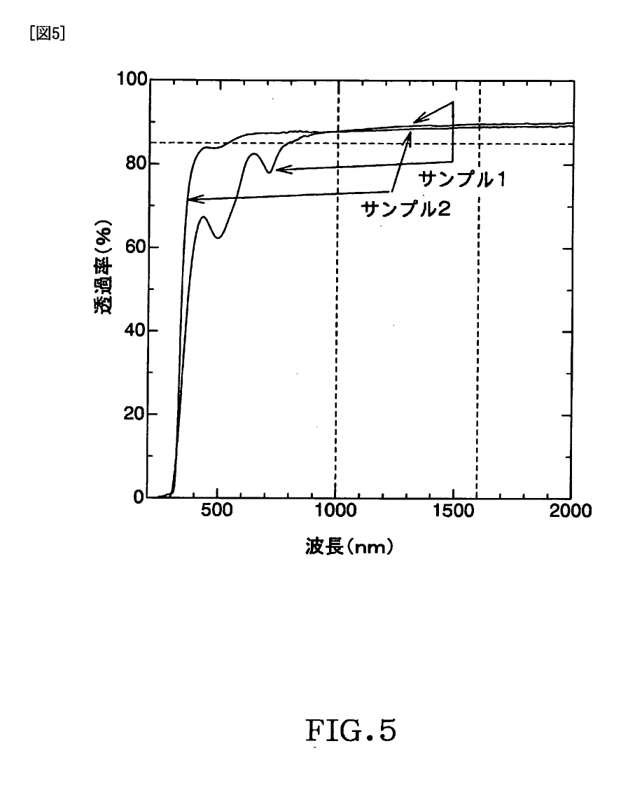

The characteristics measured on these glass samples are shown in Table 1. Each of the glass samples showed a red or red-brown color according to visual observation. In the optical transmission spectrum of each of the glass samples, optical absorption peaks are present in the wavelength range of 400 nm to 550 nm and 650 nm to 750 nm. The optical transmission spectra of samples 1 and 2 are shown in FIG. 5.

Fluorescence in the infrared region was observed in each of the glass samples. The fluorescence spectrum of the sample 1 is shown in FIG. 7. Due to the excitation induced by the irradiation of the light with each wavelength of 500 nm, 700 nm and 833 nm, emission in the wide range broadening in the wavelength of 900 nm to 1600 nm can be confirmed. In each of the glass samples including sample 1, the emission half width of 150 μm or more was obtained. In addition, in each of the glass samples, the emission lifetime (fluorescence lifetime) of 150 μs or more was obtained.

In each of the glass samples, amplification of the signal light with wavelengths of 1064 nm and 1314 nm owing to the excitation light with wavelength of 532 nm was observed. As shown in Table 1, in the all samples, the wavelength at which the emission in the fluorescence spectrum is maximum is in the wavelength region between 1064 nm and 1314 nm. Such a glass sample enables an optical amplification in at least a part of the above-mentioned wavelength region, and the optical amplification can be performed at least in the range of 250 nm, considering the emission of the glass sample in the wide wavelength range.

### REFERENCE EXAMPLES

In the manner similar to Examples, raw materials of the glass were blended so that the respective compositions shown in Table 2 were obtained and the glass samples were prepared. However, with respect to sample 11, the prepared batch was put into an alumina crucible and was maintained in an electric furnace at 1750° C. for four hours. With respect to sample 14, the prepared batch was put into an alumina crucible and was maintained in an electric furnace at 1450° C. for four hours. Thereafter, the batch was cast on an iron plate to be cooled. After this glass was maintained in an electric furnace at 600° C. for 30 minutes, the power of the furnace was turned off and the glass then was cooled slowly to room temperature. Thus, glass samples (Samples 11 to 14) were obtained.

In the manner similar to Examples, the characteristics were measured using these glass samples. The results are shown in Table 2.

Regarding 11, since the glass melt could not be cast from the crucible, it was cooled in a crucible and the glass sample was carved out. The glass sample was colored red, but many bubbles and striaes appeared. In the wavelength of 1000 to 1600 nm, only 30% of light transmittance was obtained. Regarding sample 12, a solidified product with opaque white was obtained but only a part of this solidified product was melted. Regarding sample 13, the glass melt devitrified. Regarding sample 14, although the sample 14 had a general composition of soda-lime glass, no emission in the infrared region by the irradiation of the light with wavelength of 400 to 850 nm was observed.

Hereinafter, the reasons for the limitations of the composition are explained with reference to the results of Examples and Reference Examples.

Bismuth oxide is an essential component necessary for the glass composition of the present invention to emit light or perform optical amplification. As bismuth oxide, bismuth trioxide (Bi₂O₃) or bismuth pentoxide (Bi₂O₅) is preferable. When the content of bismuth oxide is excessively low, emission intensity of bismuth oxide in the infrared region becomes too small. On the other hand, when the content is excessively high, it becomes difficult for optical absorption peak to emerge in the wavelength range of 450 to 550 nm of the optical transmission spectrum, resulting in low emission intensity in the infrared region. The content of bismuth oxide (in terms of Bi₂O₃) is preferably 0.01 to 5%, more preferably 0.01 to 3%, and particular preferably 0.1 to 3%.

A main component of the glass network former is GeO₂. As the content of GeO₂ becomes higher, the glass composition emits stronger light. However, the viscosity of the glass melt concurrently becomes too high. When the content exceeds 90%, the production of the glass composition becomes difficult. On the other hand, when the content of GeO₂ is excessively low, emission intensity of the glass composition in the infrared region deteriorates and furthermore, devitrification tends to occur. Hence, the content of GeO₂ is preferably 40 to 85%, more preferably 45 to 85%, and particularly preferably 55 to 80%.

Al₂O₃ is an essential component necessary for bismuth oxide to show the infrared emission in the glass composition. When the content of Al₂O₃ is less than 0.5%, this effect is not exerted. On the other hand, as the content of Al₂O₃ becomes higher, the emission intensity of the glass composition becomes stronger. However, when the content exceeds 33%, the meltability of the glass raw materials deteriorates. Further, even though the glass raw materials are melted completely, the glass tends to devitrify. Hence, the content of Al₂O₃ is preferably 0.5 to 33%, further preferably 5 to 30%. The lower limit is more preferably 10% and the upper limit is more preferably 20%, furthermore preferably 15%.

It is preferable to add divalent metal oxides MO (MO=MgO+CaO+SrO+BaO+ZnO) and monovalent metal oxides R₂O (R₂O=Li₂O+Na₂O+K₂O) from the viewpoint of vitrification of the composition. From this viewpoint, it is recommended to add at least 3% of MO+R₂O. As the content of MO+R₂O increases, homogenization of the glass becomes easier. On the other hand, when the content of MO+R₂O exceeds 40%, devitrification occurs very easily. Hence, the content of MO+R₂O is preferably 3 to 40%, further preferably 5 to 35%, and particularly preferably 10 to 30%.

As a part of source materials of MO and R₂O, a salt having high oxidizing ability such as a sulfate salt (MSO₄; R₂SO₄) and a nitrate salt (M(NO₃)₂; RNO₃) desirably is used, since a compound having high oxidizing ability is formed during melting, which inhibits the reduction of bismuth. Inhibition of the reduction prevents corrosion of a melting vessel such as a crucible made of platinum or platinum-alloy. The amount of the sulfate salt and the nitrate salt is preferably 1/20 in a molar ratio relative to bismuth oxide.

MgO is an important glass network modifier. MgO improves the meltability of a raw material batch. However, when the content of MgO is excessively high, the glass composition exhibits a dark blackish brown color and intensity of an optical absorption peak in the wavelength range of 400 to 550 nm becomes small. As the result of this, the emission intensity decreases sharply. When the content of MgO is excessively high, the viscosity of the glass melt becomes too low and the glass tends to devitrify. The content of MgO is preferably 0 to 40%, further preferably 0.5 to 35%, particularly preferably 0.5 to 30%, and most preferably 0.5 to 15%.

CaO, as in the case of MgO, improves the meltability of a raw material batch, and the ability of CaO to enhance the devitrification resistance of glass is superior to that of MgO. However, when the content of the CaO, as is the case with MgO, is excessively high, the glass composition exhibits a dark blackish brown color and the emission intensity decreases. Hence, the content of CaO is preferably 0 to 30%, further preferably 0 to 20%, more preferably 0 to 18%, and particularly preferably 0 to 10%.

SrO, as in the case of MgO and CaO, improves the meltability of a raw material batch. Even a small amount (e.g., 0.1% or more) of SrO improves the devitrification resistance of glass greatly. However, since SrO has a strong effect of rapidly decreasing the intensity of emission induced by bismuth, the content is preferably 0 to 30%, more preferably 0 to 15%, particularly preferably 0 to 5%, and most preferably 0 to 1%.

BaO, as in the case of MgO and CaO, improves the meltability of a raw material batch. BaO has a higher effect of improving the refractive index as compared to the other divalent metal oxides. Since the increase in refractive index results in improvement in the luster of a glass surface, the development of a red or red-brown color also is improved. Hence, it is advantageous that for instance, 0.1% or more of BaO is added. BaO, however, has a strong effect of rapidly decreasing the emission intensity, and therefore the content is preferably 0 to 30%, more preferably 0 to 15%, particularly preferably 0 to 5%, and most preferably 0 to 1%.

ZnO also improves the meltability of a raw material batch. ZnO is excellent in the effect of allowing the glass to develop a red or red-brown color as compared to CaO, SrO, and BaO. ZnO also is excellent in the effect of improving the refractive index of glass as compared to MgO. With consideration given to this, a small amount (e.g., 0.1% or more) of ZnO may be added. As in the case of MgO, however, when the content of ZnO is excessively high, glass exhibits a dark blackish brown color and the emission intensity decreases. When the content of ZnO is excessively high, a phase separation, which makes the glass cloudy, may occur in the glass, and transparent glass may not be obtained. Hence, the content of ZnO is preferably 0 to 25%, further preferably 0 to 15%, and more preferably 0 to 10%.

Li₂O is an important glass network modifier. Li₂O lowers melting temperature, increases the meltability, and enhances the refractive index of the glass. Since the addition of a suitable amount of Li₂O increases the light absorption and enhances the emission intensity, 0.1% or more of Li₂O is desirably added. As in the case of MgO, however, when the content of Li₂O is excessively high, the glass exhibits a dark blackish brown color and the emission intensity decreases. When the content of Li₂O is far higher, the viscosity of glass melt becomes low and the glass tends to devitrify. The content of Li₂O is preferably 0 to 30%, more preferably 0 to 15%, and most preferably 0 to 10%.

Na₂O lowers the melting temperature as well as the liquidus temperature and thereby prevents glass from devitrification. Na₂O, however, has a strong effect of weakening emission by making the glass dark blackish brown. Hence, the content of Na₂O is preferably 0 to 30%, more preferably 0 to 15%, and particularly preferably 0 to 5%.

K₂O lowers the liquidus temperature and thereby prevents glass from devitrification. K₂O, however, weakens emission of glass in the infrared region even when the amount thereof is small. Hence, the content of K₂O is preferably 0 to 30%, more preferably 0 to 15%, and particularly preferably 0 to 2%.

TiO₂ increases the refractive index of glass and promotes emission. BaO has a strong effect of decreasing the emission intensity while TiO₂ has an effect of improving the emission intensity. TiO₂, however, has an effect of making glass cloudy. Hence, the content of TiO₂ is preferably 0 to 10%, and more preferably 0 to 5%.

ZrO₂, as in the case of TiO₂, improves the refractive index of glass and promotes infrared emission. ZrO₂, however, has an effect of accelerating the crystallization of glass and increasing the density of glass. Hence, in order to avoid devitrification and increase in density, the content of ZrO₂ is preferably 0 to 5%, and more preferably 0 to 3%.

The glass composition of the present invention may contain a plurality of glass network formers, for example, may contain SiO₂. Addition of SiO₂ is effective for inhibiting devitrification. However, when the content of SiO₂ is excessively high, the viscosity of glass melt becomes extremely high and thereby homogenization of the composition is prevented. The content of SiO₂ is preferably 0 to 20%, and more preferably 0 to 10%.

For the purpose of controlling the refractive index, controlling temperature viscosity characteristics, inhibiting devitrification, and the like, the glass composition of the present invention may contain Y₂O₃, La₂O₃, Ta₂O₅, Ga₂O₃, Nb₂O₅ and In₂O₃, besides the above-mentioned components, preferably with the total content thereof being 5% or less.

Furthermore, for the purpose of allowing glass to be clear when it is melted, preventing bismuth from being reduced, and the like, the glass composition may contain As₂O₃, Sb₂O₃, SO₃, SnO₂, Fe₂O₃, Cl and F, preferably with the total content thereof being 1% or less.

In addition, components other than those described above may be introduced, as trace amounts of impurities, into glass raw materials. However, when the total content of such impurities is lower than 1%, the effect to be imposed on the physical properties of the glass composition is small and therefore does not cause any substantial problems.

The glass composition of the present invention does not require Nd, Er, Pr, Ni and Cr for exerting the function of emission and optical amplification, and therefore may be substantially free from these elements. Herein, the expression “substantially free from” means that the content of these elements that is obtained by the conversion of these elements into the most stable oxides in the glass is less than 1%, preferably less than 0.1%.

| | Sample | | | | | | |
|---|---|---|---|---|---|---|---|
| | 1 | 2 | 3 | 4 | 5 | 6 | 7 |
| Composition (mol %) | | | | | | | |
| GeO₂ | 79.4 | 59.7 | 49.6 | 84.9 | 56.9 | 65.8 | 53.2 |
| Al₂O₃ | 9.9 | 10.0 | 19.8 | 6.0 | 6.0 | 9.7 | 20.9 |
| Li₂O | 9.9 | 0 | 0 | 4.0 | 0 | 14.6 | 0 |
| Na₂O | 0 | 5.0 | 0 | 0 | 0 | 0 | 0 |
| K₂O | 0 | 0 | 0 | 0 | 8.0 | 0 | 0 |
| MgO | 0.5 | 10.0 | 0.5 | 1.0 | 19.0 | 1.0 | 1.9 |
| CaO | 0 | 10.0 | 29.8 | 0 | 0 | 3.9 | 0 |
| SrO | 0 | 0 | 0 | 3.0 | 0 | 0 | 4.3 |
| BaO | 0 | 0 | 0 | 0 | 3.0 | 0 | 3.4 |
| TiO₂ | 0 | 0 | 0 | 0 | 0 | 2.0 | 2.7 |
| ZrO₂ | 0 | 0 | 0 | 1.0 | 2.0 | 0 | 0 |
| ZnO | 0 | 5.0 | 0 | 0 | 0 | 0.0 | 9.6 |
| SiO₂ | 0 | 0 | 0 | 0 | 5.0 | 0 | 3.0 |
| Bi₂O₃ | 0.3 | 0.3 | 0.3 | 0.1 | 0.1 | 3.0 | 1.0 |
| MO + R₂O | 10.4 | 29.9 | 30.3 | 8.0 | 30.0 | 19.4 | 18.2 |
| Optical absorption peak | | | | | | | |
| In range of 400 to 550 nm | Observed | Observed | Observed | Observed | Observed | Observed | Observed |
| | | | (weak) | (weak) | (weak) | | |
| In range of 650 to 750 nm | Observed | Observed | Observed | Observed | Observed | Observed | Observed |
| | | (weak) | (weak) | (weak) | (weak) | (weak) | |
| Transmittance of sample with 3 | | | | | | | |
| mm thickness (%) | | | | | | | |
| Minimum value from 1000 to | 88 | 88 | 87 | 88 | 85 | 80 | 82 |
| 1600 nm | | | | | | | |
| Fluorescence spectrum Excited | | | | | | | |
| at 500 nm | | | | | | | |
| Emission peak wavelength/nm | 1126 | 1201 | 1200 | 1130 | 1140 | 1120 | 1135 |
| Emission half width/nm | 244 | 242 | 238 | 241 | 240 | 235 | 236 |
| Excited at 700 nm | | | | | | | |
| Emission peak wavelength/nm | 1085 | 1099 | 1090 | 1095 | 1085 | 1095 | 1090 |
| Emission half width/nm | 167 | 216 | 180 | 175 | 190 | 195 | 170 |
| Excited at 833 nm | | | | | | | |
| Emission peak wavelength/nm | 1254 | 1308 | 1280 | 1260 | 1270 | 1290 | 1280 |
| Emission half width/nm | 439 | 263 | 270 | 280 | 300 | 350 | 320 |
| Fluorescence lifetime/μs | | | | | | | |
| Excited at 500 nm | 316 | 302 | 290 | 280 | 285 | 305 | 310 |
| Measured at 1140 nm | | | | | | | |
| Excited at 700 nm | 417 | 311 | 320 | 310 | 315 | 320 | 310 |
| Measured at 1120 nm | | | | | | | |
| Excited at 833 nm | 232 | 296 | 220 | 230 | 225 | 240 | 235 |
| Measured at 1250 nm | | | | | | | |
| Optical amplification | Observed | Observed | Observed | Observed | Observed | Observed | Observed |
| Refractive index | 1.622 | 1.656 | 1.658 | — | — | — | — |
| Abbe number | 45 | — | — | — | — | — | — |
| Coefficient of linear expansion/ | 72 | 65 | — | — | — | — | — |
| 10⁻⁷ ° C.⁻¹ | | | | | | | |
| Glass transition temperature/ | 542 | 632 | — | — | — | — | — |
| ° C. | | | | | | | |
| Deformation point/° C. | 602 | 676 | — | — | — | — | — |

Remarks: Transmittance is raw measured value including Fresnel reflection loss on the sample surface.

TABLE 2

| | Sample | | | |
|---|---|---|---|---|
| | 11 | 12 | 13 | 14 |
| Composition | | | | |
| (mol %) | | | | |
| GeO₂ | 0 | 49.9 | 51.3 | 0 |
| Al₂O₃ | 2.2 | 49.8 | 5.9 | 2.3 |
| Li₂O | 0 | 0 | 0 | 0 |
| Na₂O | 0 | 0 | 16.3 | 13.0 |
| K₂O | 0 | 0 | 0 | 0 |
| MgO | 0 | 0 | 9.2 | 6.0 |
| CaO | 0 | 0 | 9.6 | 8.0 |
| SrO | 0 | 0 | 0 | 0 |
| BaO | 0 | 0 | 6.7 | 0 |
| TiO₂ | 0 | 0 | 0 | 0 |
| ZrO₂ | 0 | 0 | 0 | 0 |
| ZnO | 0 | 0 | 0 | 0 |
| SiO₂ | 97.5 | 0 | 0 | 70.2 |
| Bi₂O₃ | 0.3 | 0.3 | 1.0 | 0.5 |
| MO + R₂O | 0 | 0 | 41.8 | 27.0 |
| State of glass | Vitrified | Impossible | Devitrified | Vitrified |
| | | to melt | | |
| Color of glass | Red | White | blackish | Colorless |
| | transparent | opaque | brown | transparent |
| | Many | | opaque | |
| | bubbles | | | |
| Optical | | | | |
| absorption peak | | | | |
| 400 to 550 nm | Observed | — | — | None |
| 650 to 750 nm | Observed | — | — | None |
| Transmittance of | 30 | — | — | 90 |
| sample with 3 mm | | | | |
| thickness (%) | | | | |
| Minimum value | | | | |
| from 1000 to | | | | |
| 1600 nm | | | | |

### INDUSTRIAL APPLICABILITY

The glass composition of the present invention can be used in the 1310 nm range, which is one of the wavelength regions mainly used for optical communication, and 1064 nm, which is an oscillation wavelength of a Nd:YAG laser. According to the present invention, a novel optical amplification media can be provided that works in the wavelength range of 1100 to 1300 nm in which an appropriate optical amplification material had never been reported. The glass composition of the present invention can provide a wide fluorescence spectrum broadening in 900 nm to 1600 nm at least in the preferred embodiment. By applying this, the optical amplifier that works in this wide wavelength range can be provided.

1. A glass composition comprising bismuth oxide, aluminium oxide, and a glass network former, wherein a main component of the glass network former is germanium dioxide, and bismuth contained in bismuth oxide functions as an emission species and emits fluorescence in the infrared wavelength region by irradiation of excitation light.

2. The glass composition according to claim 1, which has an optical absorption peak in the wavelength range of 400 nm to 1100 nm.

3. The glass composition according to claim 1, wherein the wavelength at which the intensity of fluorescence induced by the irradiation of excitation light with wavelength in the range of 400 nm to 1100 nm is maximum is in the range of 900 nm to 1600 nm.

4. The glass composition according to claim 1, wherein a half width to the wavelength of the fluorescence is at least 150 nm.

5. The glass composition according to claim 4, wherein the half width to the wavelength of the fluorescence is at least 320 nm.

6. The glass composition according to claim 1, which provides gain of signal light in at least a part of the wavelength range of 900 nm to 1600 nm.

7. The glass composition according to claim 1, which further comprises a monovalent or divalent metal oxide.

8. The glass composition according to claim 7, wherein the divalent metal oxide is at least one selected from MgO, CaO, SrO, BaO and ZnO.

9. The glass composition according to claim 7, wherein the monovalent metal oxide is at least one selected from Li₂O, Na₂O and K₂O.

10. The glass composition according to claim 7, wherein the content of the monovalent or divalent metal oxide is in the range of 3 to 40 mol %.

11. The glass composition according to claim 1, wherein the content of bismuth oxide in terms of Bi₂O₃ is in the range of 0.01 to 15 mol %.

12. The glass composition according to claim 11, wherein the content of bismuth oxide in terms of Bi₂O₃ is in the range of 0.01 to 5 mol %.

13. The glass composition according to claim 1, wherein the content of aluminium oxide is in the range of 0.5 to 33 mol %.

14. The glass composition according to claim 1, wherein the content of germanium dioxide is in the range of 40 to 85 mol %.

15. The glass composition according to claim 10, wherein the glass composition comprises the following components, indicated by mol %:
40 to 85 GeO₂;
0.5 to 33 Al₂O₃;
0 to 30 Li₂O;
0 to 30 Na₂O;
0 to 30 K₂O;
0 to 40 MgO;
0 to 30 CaO;
0 to 30 SrO;
0 to 30 BaO;
0 to 25 ZnO;
0 to 10 TiO₂;
0 to 5 ZrO₂; and
0 to 20 SiO₂,
the total of MgO+CaO+SrO+BaO+ZnO+Li₂O+Na₂O+K₂O is in the range of 3 to 40 mol %, and
the content of bismuth oxide in terms of Bi₂O₃ is 0.01 to 15 mol %.

16. An optical fiber comprising the glass composition according to claim 1.

17. An optical amplifier comprising the glass composition according to claim 1.

18. A method of amplifying signal light, comprising injecting excitation light and signal light into the glass composition according to claim 1 to amplify the signal light.
